(19) United States
(12) Patent Application Publication
(10) Pub. No.: US 2018/0001545 A1
(43) Pub. Date: Jan. 4, 2018

(54) MULTIPLE SUPPORT MATERIALS FOR ACCELERATED POST-PROCESSING OF THREE-DIMENSIONALLY PRINTED OBJECTS

(71) Applicant: Xerox Corporation, Norwalk, CT (US)

(72) Inventors: Erwin Ruiz, Rochester, NY (US); Ron E. Dufort, Rochester, NY (US); Linn C. Hoover, Webster, NY (US); Mandakini Kanungo, Penfield, NY (US); Patrick J. Howe, Fairport, NY (US)

(21) Appl. No.: 15/200,964

(22) Filed: Jul. 1, 2016

(51) Int. Cl. B29C 64/112; B29C 64/386; B33Y 80/00; B33Y 50/02; B33Y 40/00; B29C 64/40; B33Y 10/00

(52) U.S. Cl. CPC B29C 64/112; B29C 64/40; B29C 64/386; B33Y 10/00; B33Y 50/02; B33Y 40/00; B33Y 80/00

(57) ABSTRACT

A three-dimensionally printed object includes build portions formed with a build material, first support portions formed with a first support material, and second portions formed with a second support material that is different than the first support material. The first and second support portions are arranged with the build portions such that the build portions are supported and protected during fabrication of the object. The arrangement is optimized to minimize a time period for removing the first and second support materials from the object and releasing the build portions. A method of producing the object includes operating ejectors of a three-dimensional object printer to form the build portion, first support portions, and the second support portions. The portions are formed with reference to the arrangement.

### TECHNICAL FIELD

This disclosure relates generally to three-dimensionally printed objects, and more particularly to techniques for facilitating post-processing of three-dimensionally printed objects.

### BACKGROUND

Digital three-dimensional object manufacturing, also known as digital additive manufacturing, is a process of making a three-dimensional solid object of virtually any shape from a digital model. Three-dimensional object printing is an additive process in which successive layers of material are formed on a substrate in different shapes, and is distinguishable from traditional object-forming techniques, which mostly rely on the removal of material from a work piece by a subtractive process, such as cutting or drilling. The layers can be formed by ejecting binder material, directed energy deposition, extruding material, ejecting material, fusing powder beds, laminating sheets, or exposing liquid photopolymer material to a curing radiation. The substrate on which the layers are formed is supported either on a platform that can be moved three dimensionally by operation of actuators operatively connected to the platform, or the material deposition devices are operatively connected to one or more actuators for controlled movement of the deposition devices to produce the layers that form the object. Typically, ejector heads, which are similar to printheads in document printers, include an array of ejectors that are coupled to a supply of material. Ejectors within a single ejector head can be coupled to different sources of material or each ejector head can be coupled to different sources of material to enable all of the ejectors in an ejector head to eject drops of the same material. Materials that become part of the object being produced are called build materials, while materials that are used to provide structural support for object formation, but are later removed from the object are known as support materials. Generally, both build materials and support materials are ejected during the formation of each layer to form build portions of a three-dimensional objet with build material and form support portions with the support material that support the build portions. An example of a prior art three-dimensional object 10 having build portions 12 supported by support portions 14 is illustrated in the top cross-section view of FIG. 16.

Different support materials have different physical properties, including rigidity, solubility, and phase change properties. As a result, different processes are used to remove different support materials. Additionally, different support materials are generally used to support different build materials of different shapes. In some examples, the three-dimensional object is cured prior to the removal of support materials so the support portions are no longer needed after curing of the build portions.

In one example, a support material has a lower melting point than a build material. The support material is removed via a phase change operation that includes placing the three-dimensionally printed object into an oven or heated liquid bath having a temperature above the melting point of the support material but below the melting point of the build material. This process generally takes several hours or more, and may require secondary cleaning, such as additional washing or handling, to remove all support material from the object. Build materials are also limited to materials having a melting temperature higher than the melting temperature of the support material.

In another example, a support material is soluble in a solvent, such as water or another chemical. Removing the support material includes placing the three-dimensionally printed object in a bath of the solvent, or washing off the support material via a fluid stream of pressurized solvent. This process can also take several hours, may also require secondary cleaning, and limits the build material to materials that do not dissolve in the solvent.

In a further example, a support material is friable. Removing the support material includes a mechanical removal process or a power washing process. This process may be relatively quick compared to other methods, but may require secondary cleaning. Additionally, the mechanical removal process or power washing process may include forces that could damage the build material portions. Such a process limits the build materials that can be used and the design of the object to structures that reduce the risk of breakage during the removal process.

Generally, support materials that can be removed faster, such as frangible or friable support materials, provide less physical support relative to other support materials. One technique for compensating between decreased physical support and decreased removal time includes incorporating additional build material to make the support section more resilient. In one example, illustrated in the top cross-sectional view of a prior art object in FIG. 17, an additional shell 20 of build material encapsulates an interior structure 30 that includes portions of support material 14 and portions of build material 12. In some examples of this technique (not shown), the shell 20 also extends over the top or bottom of the object 10. Since the shell 20 is formed from build material, releasing the build portions 12 from the shell 20 may be difficult if the build portions 12 and shell 20 are touching. This requirement may limit the size and shape of build portions printable via this technique. In another example illustrated in the top cross-section view of the object in FIG. 18, additional build material 50 is interspersed with the support portions 14. The interspersed build material bolsters a physical support provided by the support portions 14. However, in some cases, a shell as in the example illustrated in FIG. 17 is required to prevent support material from leaking from the object. These configurations, however, may result in an increase in the time needed to remove the support material from the three-dimensional object, since the additional build material must also be removed. Additionally, build material generally has a high cost relative to support material, and the additional build material needed to supplement the physical support of the support material can greatly increase the cost of materials for printing the three-dimensional object.

The generally long times needed to remove support material from three-dimensional objects greatly increases total object production time. Additionally, the geometry of the portions formed using build materials, the physical properties of the build material, and the physical properties of the support material place limitations on the types of three-dimensional objects that can be printed. Removing support material becomes especially complex when the object portions formed with build material are fragile or intricate. Therefore, techniques for reducing the time needed to remove support material without compromising the physical support of the build material would be beneficial.

### SUMMARY

In order to facilitate the removal of support materials from three-dimensionally printed objects, a three-dimensionally printed object according to this disclosure includes build portions formed with a build material, first support portions formed with a first support material, and second portions formed with a second support material that is different than the first support material.

In an embodiment, the first and second support portions are arranged with the build portions such that the build portions are supported and protected during fabrication of the object. The arrangement is optimized to minimize a time period for removing the first and second support materials from the object and releasing the build portions.

A method of producing the object includes operating different ejectors of a three-dimensional object printer to eject drops of different material. A first plurality of ejectors is operated to eject drops of a build material to form portions of a three-dimensionally printed object with the build material. A second plurality of ejectors is operated to eject drops of a first support material to form portions of a three-dimensionally printed object with the first support material. A third plurality of ejectors is operated to eject drops of a second build material that is different from the first build material to form portions of a three-dimensionally printed object with the second support material.

In an embodiment, prior to forming the three-dimensionally printed object, a support condition of the portions to be formed with the build material is identified. An arrangement of the portions to be formed with the first support material and the portions to be formed with the second support material is generated that supports the portions formed with the build material during the formation process, and that optimizes for a minimum time period for removing the first and second support materials from the three-dimensionally printed object. The three-dimensionally printed object is the formed with the ejectors with reference to the generated arrangement.

The portions formed with the second support material can be removed from the three-dimensionally printed object via a first removal process that does not remove or at least does not completely remove the portions formed with the first support material. The portions formed with the first support material can then be removed via a second removal process that is different than the first removal process.

### BRIEF DESCRIPTION OF THE DRAWINGS

The foregoing aspects and other features of the present disclosure are explained in the following description, taken in connection with the accompanying drawings.

FIG. 1 is a top cross-section view of an exemplary embodiment of a three-dimensionally printed object printed according to this disclosure.

FIG. 2 is a top cross-section view of the object of FIG. 1 after certain portions formed from a support material have been removed.

FIG. 3 is a top cross-section view of another exemplary embodiment of a three-dimensionally printed according to this disclosure.

FIG. 4 is a top cross-section view of the object of FIG. 3 after certain portions formed from a support material have been removed.

FIGS. 5-8 are top cross-section views additional different exemplary embodiments of a three-dimensionally printed according to this disclosure.

FIG. 9 is a top cross-section view of the object of FIG. 8 after certain portions formed from a support material have been removed.

FIG. 10 is a top cross-section view of another exemplary embodiment of a three-dimensionally printed according to this disclosure.

FIG. 11 is a top cross-section view of the object of FIG. 10 after certain portions formed from a support material have been removed.

FIG. 12 is a schematic of an exemplary computing device configured according to this disclosure.

FIG. 13 is a flow diagram of an exemplary method of generating an arrangement of different portions of a three-dimensionally printed object formed with different materials according to this disclosure.

FIG. 14 is a schematic illustrating an exemplary embodiment of a three-dimensional object printer for printing a three-dimensionally printed object according to this disclosure.

FIG. 15 is a flow diagram of an exemplary method of operating a three-dimensional object printer to form a three-dimensionally printed object according to this disclosure.

FIGS. 16-18 are top cross-section views of different three-dimensionally printed objects having portions formed from different materials disposed in known arrangements.

### DETAILED DESCRIPTION

For a general understanding of the present embodiments, reference is made to the drawings. In the drawings, like reference numerals have been used throughout to designate like elements.

This disclosure proposes using multiple different support materials during object production to accelerate the removal of support material from the object, reduce risk of damage to portions of the object formed with build material during the removal of support material, lower object production costs, and facilitate the separation of different parts and assemblies within a printed object. Different arrangements of different support materials according to this disclosure, as discussed below, leverage the physical properties of the different support materials to optimize the removal of the support materials without negatively impacting the formation of portions with the build material.

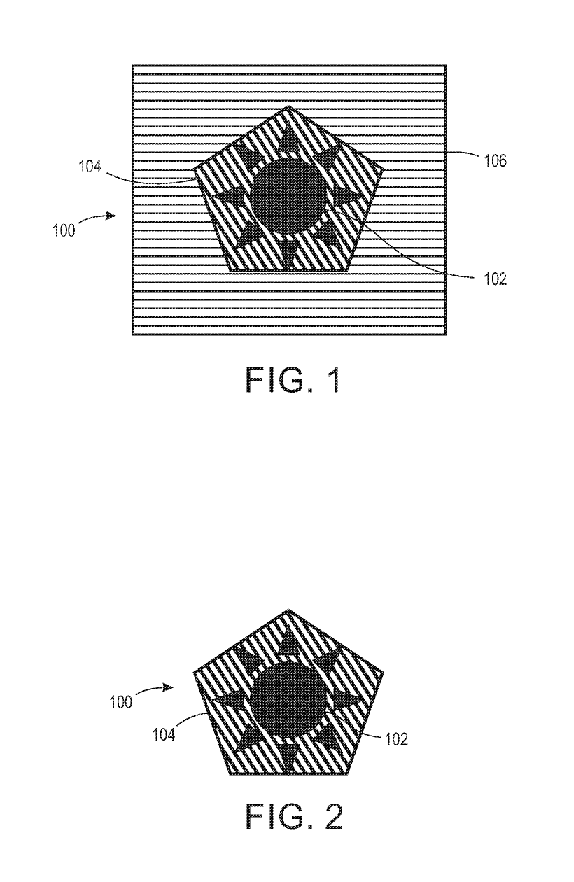

FIG. 1 illustrates a top cross-section view of an exemplary embodiment of a three-dimensionally printed object 100 that supports and protects build portions while enabling the accelerated removal of support material according to this disclosure. The object 100 includes portions formed from a build material referred to as build portions 102, portions formed from a first support material referred to as first support portions 104, and portions formed from a second support material that is different from the first build material referred to as second support portions 106. In this embodiment, at least one first support portion 104 at least partially surrounds at least one build portion 102. Additionally, at least one second support region 106 at least partially surrounds the at least one first support portion 104 that at least partially surrounds the at least one build portion 102.

In this embodiment, the first support material is rigid after being deposited to form the first support portions 104, or after the object 100 is cured, and can be removed via a phase change operation or dissolution operation. In contrast, the second support material that forms the second support portions 106 is friable relative to the build material and the first support material, and can be quickly removed by a mechanical process or power-washing process. The first support portions 104 provide sufficient support for the build portions 102 and protect the build portions 102 during the removal of the second support portions 106. In other words, the portion of first support material 104 surrounding the build portions 102 provides a rigid shell that protects the build portions 102 during the mechanically intensive process of removing the friable second support portions 106. This enables the use of mechanically intensive removal processes to rapidly remove significant portions of the support materials in the object 100 without damaging the build portions 102.

FIG. 2 illustrates a state of the object 100 of FIG. 1 after a relatively brief removal process has removed the second support portions 106 from the object 100 so only the first support portions 104 and build portions 102 remain. A brief removal process takes only a few minutes or less. Since the amount of first support material in the first support portions 104 is significantly less than, for example, the amount of first support material in the support portions 14 of the object 10 illustrated in FIG. 16, the time needed to perform the relatively more time consuming process of removing the first support material is significantly accelerated. In other words, because the time needed to perform a phase change or dissolution process generally corresponds with the amount of material being removed, the total support material removal time is accelerated since less first support material needs to be removed. This configuration leverages the rigid protection of the first support material with the rapid removal of the second support material to support and protect the build portions 102 during the production process and accelerate the total time for removing support materials from the object 100. As an example, the build portions 102 are released from the second support portions 106 and first support portions 104 much faster than the 3-4 hours needed to release the build portions 12 from the support portions 14 using known techniques. In an example, the build portions are released 3 or more times faster than via known techniques, or in particular as much as 40 times faster or more, depending on the materials selected for the first support material and second support material.

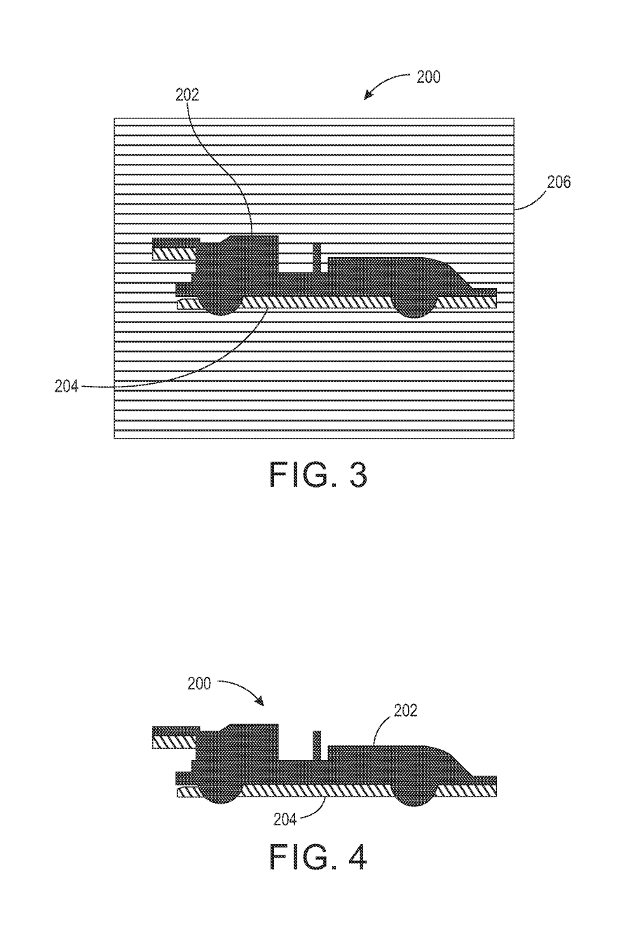

In the embodiment illustrated in FIGS. 1 and 2, the first support portions 104 completely surround the build portions 102. However, other configurations are also contemplated. FIG. 3 illustrates a top cross-section view of another exemplary embodiment of a three-dimensionally printed object 200 according to this disclosure. The object 200 includes build portions 202 formed from a build material, first support portions 204 formed from a first support material, and second support portions 206 formed from a second support material different than the first support material.

In this embodiment, the build material is an elastomer material that generally is at risk of deformation during phase change operations. In an example, a phase change operation generally involves the removal of a support material by raising a temperature of the object above a melting point of the support material. The support material melts away and is removed from the object. To avoid damage or deformation of the build portions of the object, the temperature of the phase change operation is generally set below a melting point of the build material. However, some build materials, like some varieties of elastomers and plastics, may deform or exhibit altered behavior even when heated to temperatures below their melting temperature. Therefore, protecting a shape of the build portions 202 of the object 200 during the phase change operation may be beneficial.

At least one first support portion 204 surrounds at least one build portion 202, at least in part, and at least one second support portion 206 surround the at least one first support portion 204 that at least partially surrounds the at least one build portion 202. The first support material is a rigid support material that can be removed via a dissolution process. The second support material can be removed via a phase change operation in which the object 200 is heated to an operation temperature above a phase change temperature or melting point of the second support material but below a phase change temperature of the first support material and a phase change temperature of the build material. As a result, raising the object 200 to the operation temperature melts away the second support material without melting away the first support material or the build material.

During the phase change operation, the rigid first support portions 204 provide rigid support to the build portions 202 to retain the shape of the build portions 202. In other words, the first support portions 204 act as a rigid skeleton that supports and protects the shape of the build portions 202 against the heat from the phase change operation. After the second support material is removed, as illustrated in FIG. 4, the first support portions 204 can be removed via a dissolution process. Since the amount of first support material in the object 200 is limited to just the material making up the rigid skeleton of the first support portions 204, the time required to carry out the dissolution process is accelerated relative to a dissolution process for removing all of the support materials in the object according to known techniques.

In an example, removing all support material from the object 200 via a dissolution process might take 6-8 hours. In contrast, removing the second support portions 206 via a phase change operation might take 1-2 hours, and removing the relatively small amount of material in the first support portions 204 via a dissolution process might take 1-2 hours, for a total time for releasing the build portions 202 of 2-4 hours.

As discussed above, support materials that are easier and faster to remove generally provide less rigid support. However, such support materials may pose less risk of damage to or may be easier to remove from certain arrangements of build material. For example, easily friable or dissolvable support material may be advantageously disposed in a region of build material that defines internal cavities, such as around axles or inside bearing races, or that define small features that are otherwise at high risk of damage.

In known techniques, as discussed above, additional build material is dispersed within such support materials to bolster the support provided to the build portions. However, build material is generally about twice as expensive as support material. Additionally, such additional build material generally cannot be reused, and thus the known techniques result in the waste of build material that significantly increases the cost of printing the object. Therefore, techniques that enable the use of softer and friable support materials without wasting additional build material would be beneficial.

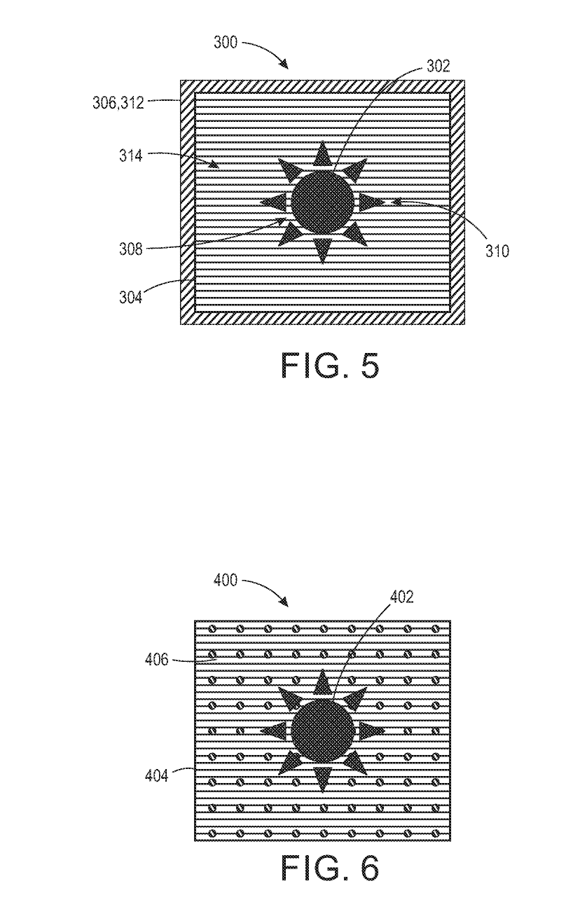

FIG. 5 illustrates a top cross-section view of another exemplary embodiment of a three-dimensionally printed object 300 according to this disclosure. The object 300 includes build portions 302 formed with build material, first support portions 304 formed with first support material, and second support portions 306 formed with second support material different from the first support material. The first support portions 304 surround and encapsulate the build portions 302, and the second support portions 306 surround and encapsulate the first support portions 304 and the build portions 302.

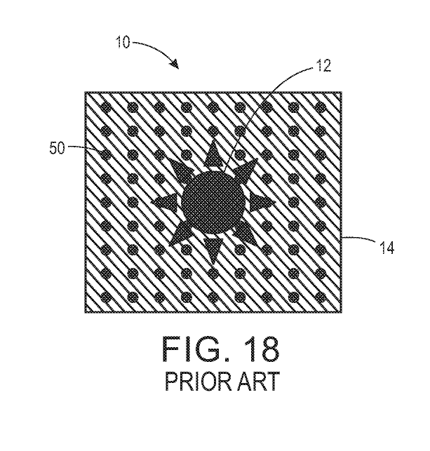

In this embodiment, the first support material is a soft or friable material. In an example, at least one first support portion 304 is disposed on a build portion that defines an internal cavity or interior region 308, or is disposed on a build portion that includes features having a small feature size 310. The second support material is a rigid material that forms a shell 312 to encapsulate an interior 314 that includes the first support portions 304 and the build portions 302. After production of the part 300 is finished, or after the part 300 has been cured, the shell 312 can be removed mechanically, or can be removed in conjunction with the removal of the first support portions 304. The first support portions 304 can be removed by a bath wash or power washing process that might take 2-4 hours. However, unlike the example illustrated in FIG. 17, no build material is wasted during the production. Additionally, since the shell 312 is formed from support material rather than build material, the shell 312 can be released from the object 300 as with other types of support material, and the difficulty related to releasing the build portions 302 from the build material of the shell 312 is decreased.

FIG. 6 illustrates a top cross-section view of another exemplary embodiment of a three-dimensionally printed object 400 according to this disclosure. The object 400 includes build portions 402 formed with build material, first support portions 404 formed with first support material, and second support portions 406 formed with second support material different from the first support material. The first support portions 404 surround and at least partially surround the build portions 402, and the second support portions 406 are interspersed within the first support portions 404.

In this embodiment, the first support material is a soft or friable material, and the second support material is a rigid material. The second support portions 406 bolster the support of the first support portions 404. Since the second support portions 406 are interspersed within the first support portions 404, the second support portions 406 can be removed during a removal process for removing the first support portions 404. For example, the first support portions 404 can be formed from a material that can be removed via a power washing process. Once the first support portions 404 are removed, the second support portions 406 are also removed, and the build portions 402 are released. Since no additional build material is used to bolster the support provided by the first support material, no additional build material is wasted, in contrast to the example illustrated in FIG. 18.

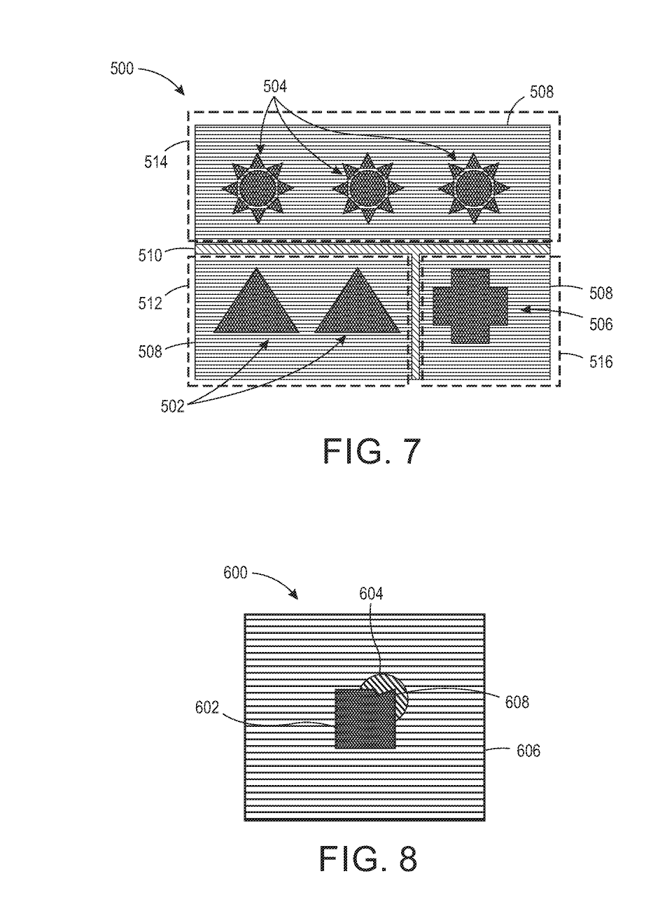

Using different support materials that can be removed via different removal processes can be beneficial for a variety of reasons. FIG. 7 illustrates a top cross-section view of another exemplary embodiment of a three-dimensionally printed object 500 according to this disclosure. The object 500 includes first build portions 502, second build portions 504, and third build portions 506 formed from a build material, first support portions 508 formed from a first support material, and second support portions 510 formed from a second support material different from the first support material. The first support portions 508 surround the first build portions 502, second build portions 504, and third build portions 506, and the second support portions 510 segment the object 500 into a first region 512 that includes the first build portions 502, a second region 514 that includes the second build portions 504, and a third region 516 that includes the third build portions 506.

In this embodiment, the first support material is a rigid material that can be removed, for example, by a phase change operation or a dissolution operation. The second support material is a frangible, friable, or soft material that forms a boundary skin 510 that separates the first support portions 508 into the different regions 512, 514, and 516 that respectively include the different build portions 502, 504, 506. Using this configuration, a single object 500 is printed that can include multiple different parts corresponding to the different build portions 502, 504, 506. The different regions 512, 514, and 516 can be separated by removing or breaking apart the second support portions 510.

In one example, this configuration is used to include different parts within a single object. In other words, rather than printing separate objects that each include build material forming a different part, build portions forming different parts are consolidated into a single object. The different parts can be for different orders or can be different parts of a common assembly. In another example, different parts are consolidated into one object for storage so the object can be broken apart to separate the different parts for distribution, use, transport, or the like.

FIG. 8 illustrates a top cross-section view of a further exemplary embodiment of an object 600 according to this disclosure. The object 600 includes build portions 602 formed with a build material, first support portions 604 formed with a first support material, and second support portions 606 formed with a second support material different than the first support material. The first support portions 604 at least partially surround the build portions 602, and the second support portions 606 at least partially surround the first support portions 604 and the build portions 602.

The build portions 602 respectively include features of different sizes, such as the small feature 608. In this embodiment, the second support material can be removed via a process that poses a risk of damage to features of a relatively small size. For example, the second support portions 606 can be configured to be removed via a power washing process that may damage a small feature 608 on the build portions 602. In another example, the second support portions 606 can be configured to be removed via a phase change process. The phase change temperature may be too low to risk damage to large portions of build material, but smaller portions, such as the small feature 608, may be less resistant to heat or other deformation forces resulting from the phase change operation.

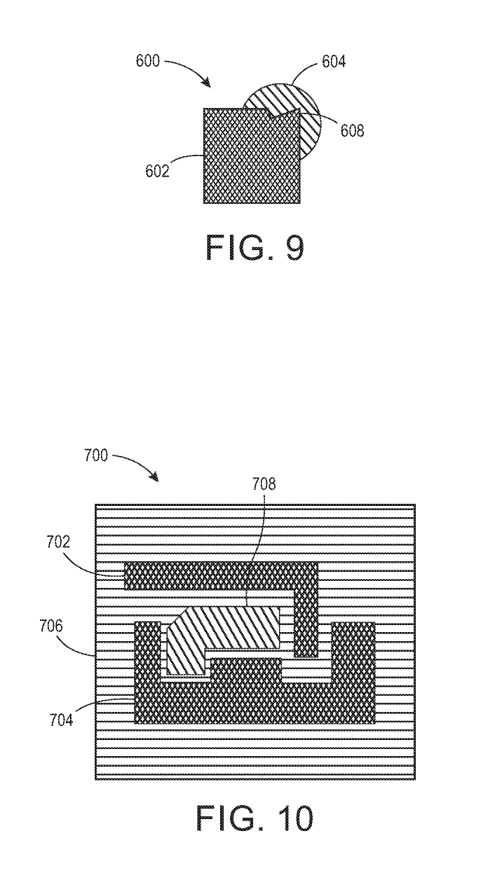

A threshold feature size that defines a minimum feature size at which the process for removing support materials in the object does not pose a risk of damage depends on the physical properties of the build material and the type of removal process being used. In this embodiment, the feature 608 of the build portions 602 is below a threshold feature size for removing the second support portions 606. The first support portions 604 are disposed on the build portions 602 to encapsulate the feature 608. The first support material is configured not to be removed during the process of removing the second support portions 606 so it provides support and protection for the feature 608 during that removal process. By using this configuration, removal processes can be used on an object even when the build portions include features that would otherwise be damaged by such removal processes. After the second support portions 606 have been removed, as illustrated in FIG. 9, the first support portions 604 can be removed by a different removal process. Since the first support material used in the object is limited to features below the threshold feature size, such as feature 608, the limited amount of first support material can be removed from the object 600 in a relatively brief time period.

In other embodiments, rather than placing portions of first support material on the build portions of an object based on a threshold feature size, portions of first support material are placed on certain portions of build material based on other criteria or for other reasons. For example, portions of first support material can be placed on frangible or fragile portions of build material, on portions of build material with a narrow tolerance for shape variation or deformation, on portions of build material subject to relatively higher loads, or for other reasons.

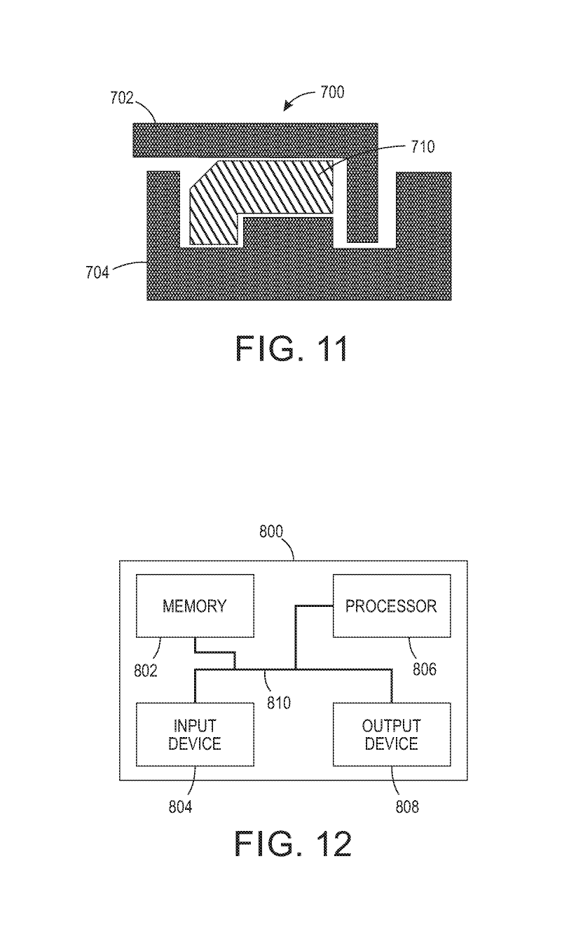

FIG. 10 illustrates a side cross-section view of another exemplary embodiment of an object 700 according to this disclosure. The object 700 includes first build portions 702 and second build portions 704 formed from a build material, first support portions 706 formed from a first support material, and second support portions 708 formed from a second support material different than the first support material. In this embodiment, the first build portions 702 and second build portions 704 correspond to different parts, but in other embodiments, the build portions can correspond to duplicates of a same part, or different integral portions of a single part. The first support portions 706 at least partially surround the first and second build portions 702 and 704 to provide support for the build material during the production process. The second support portions 708 are disposed between the first and second build portions 702 and 704 such that the second support portions 708 are configured to act as a support 710 separating the first and second build portions 702 and 704 from each other once the first support material has been removed from the object 700, as illustrated in FIG. 11.

As illustrated in FIG. 10, while the first support portions 706 remain in the object 700, the second support portions 708 are separated from the build portions 702 and 704 by first support material. As a result, the second support portions 708 are not connected to the build portions 702 and 704 once the first support portions 706 have been removed so that the build portions 702 and 704 and the second support portions 708 can be physically separated. In one embodiment, the different parts formed by the build portions 702 and 704 are to be packaged together, and the second support portions 708 are configured to act as a packaging support once the first support portions 706 are removed from the object 700. Since the second support portions 708 are separated from the build portions 702 and 704 by the first support material, as shown in FIG. 10, the second support portions 708 are released from the build portions 702 and 704.

In another embodiment, the build portions 702 and 704 are integral portions of a common part. For instance, the build portion 704 can define an offset side portion that connects the build portions 702 and 704. Since FIGS. 10 and 11 are cross-section views, such an offset side portion would be out of the plane and thus not visible in FIGS. 10 and 11. The second support portions 708 inhibit the build portion 704 from bending toward the build portion 702 to prevent damage to the object 700, such as the object 700 breaking along a break-line in the offset side portion between the build portions 702 and 704. In one embodiment, the shape of the integral build portions 702 and 704 may physically obstruct the second support portions 708 from being removed. A second removal process such as a dissolution process can be used to remove the second support material.

While the techniques above are presented in different embodiments, in other embodiments, multiple techniques discussed above are combined into the configuration of a single object. For instance, in one embodiment an object includes rigid support material to form a shell or internal supports, as illustrated in the embodiments in FIGS. 5, 6, 10, and 11, support materials that define separate regions, as illustrated in FIG. 7, and rigid support material disposed on a fragile region of build material, as illustrated in the embodiments in FIGS. 1-4 and 8-9. In some embodiments, incorporating multiple techniques into a single object includes the incorporating of additional different support materials along with the first and second support materials.

Additionally, while support materials of various types were discussed in the description of the various embodiments above, any acceptable type of support material that can be removed from an object without damaging build material can be used, and the particular types of support materials in the embodiments above can be substituted for other acceptable types of support materials. Generally, different support materials according to this disclosure are grouped together in a single object such that the process for removing one of the support materials does not remove or damage the other. For example a first support material can be configured to dissolve in a solvent that does not dissolve a second support material, and vice versa. In another example, the first support material can be configured to dissolve in a solvent having a ph factor that is less than the ph factor of the solvent in which the second material dissolves. In a further example, one of the support materials can be friable so it can be removed with pressurized fluid while another support material is rigid so it remains when the pressurized fluid strikes it. In another example, different support materials are configured to have different phase change temperatures such that raising the object to the phase change temperature of one support material does not melt the other support material. However, in other embodiments, such as when a second support material is interspersed with a first support material, a single removal process can be used to remove multiple support materials.

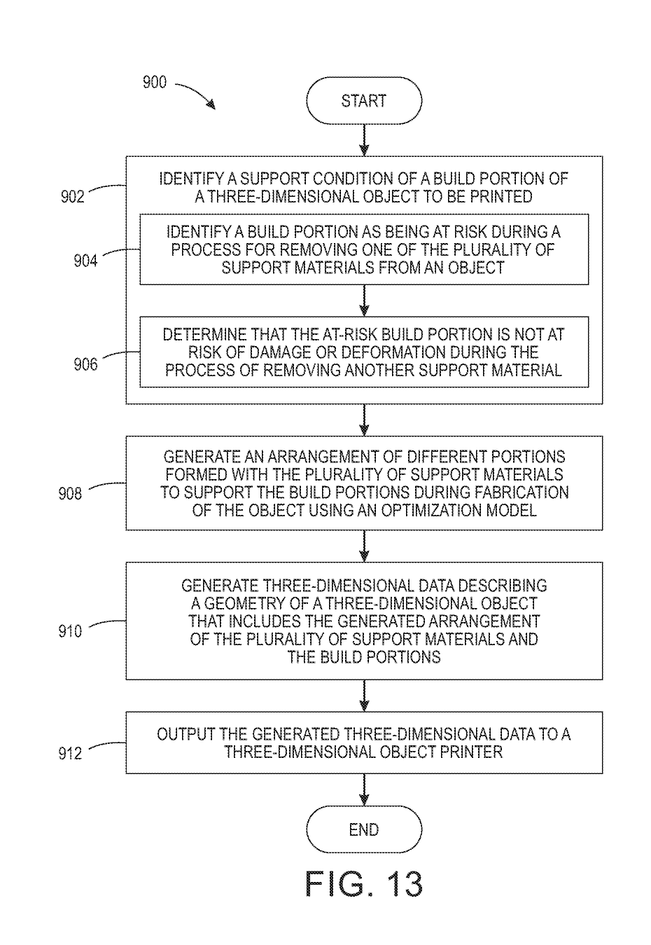

Generally, the techniques discussed above can be applied to support and protect build portions of arbitrary shape, size, and quantity. However, as the complexity and quantity of the build portions in an object increases, the difficulty rises for determining an arrangement of different support materials that both sufficiently supports and protects the build portions and that optimizes a minimum time for removing the support materials. FIG. 12 illustrates an exemplary embodiment of a computing system 800 configured to execute the exemplary method 900 illustrated in FIG. 13 for determining an arrangement of first and second support materials along with build material for forming a three-dimensionally printed object according to this disclosure. As shown in FIG. 12, the system 800 includes a memory 802, an input device 804, a processor 806, and an output device 808, which are interconnected via a system bus 810.

The input device 804 is configured to receive three-dimensional data describing a geometry of build portions of a three-dimensional object, and store the three-dimensional data in the memory 802. For example, the three-dimensional data may include three-dimensional shape data, printing layer data, object material data, or other data that enables the three-dimensional printer to print the build portions of a three-dimensional object. The memory 804 also includes data describing the physical properties of a build material, data describing physical properties of a plurality of different support materials, data describing a plurality of removal processes corresponding to the plurality of support materials, data describing various arrangements of different support materials in conjunction with build portions, such as the arrangements discussed with regard to the various techniques above, and an optimization model that is discussed in more detail below.

The processor 806 is configured with programmed instructions stored in the memory 804 that enable the processor to generate three-dimensional data describing a geometry of a three-dimensional object. This geometry arranges the build portions with a plurality of support materials to sufficiently support and protect the build portions during fabrication of the object, while minimizing a time to remove the support materials from the object. The processor 806 is configured to perform the following process illustrated in the method of FIG. 13, and the output device 808 is configured to output the generated three-dimensional data describing the geometry of the three-dimensional object to a three-dimensional object printer.

In the process 900, a support condition of the build portions is identified with reference to the data describing the physical properties of the build material and the three-dimensional data describing the geometry of the build portions (block 902). As used in this document, the term “support condition” means an amount of physical support that enables the build portions to retain a shape defined by the three-dimensional data describing the geometry of the build portions, a threshold amount of force that can be applied to a build portion without causing damage or deformation of the build portion, or both. In other words, the support condition defines the role to be filled in the object by the arrangement of the support materials to support and protect the build portions during fabrication of the object.

The identification of the support condition (block 902) optionally includes identifying a build portion as being at risk of damage or deformation during a process for removing one of the plurality of support materials from an object, with reference to the three-dimensional data describing the geometry of the build portions and the data describing the plurality of removal processes corresponding to the plurality of support materials (sub-block 904). For example, a build portion can be identified as having a feature size that is below a threshold feature size that would be damaged during a pressurized wash process for removing a particular support material. The identifying of the support condition (block 902) optionally further includes determining that the build portion identified as being at risk of damage or deformation during the process of removing the particular support material is not at risk of damage or deformation during the process of removing another support material with reference to the three-dimensional data describing the geometry of the build portions and the data describing the plurality of removal processes corresponding to the plurality of support materials (sub-block 906).

An arrangement of different portions formed with the plurality of support materials to support the build portions during the fabrication of the object is generated using an optimization model stored in the memory 804 (block 908). The optimization model is configured to optimize the arrangement for a minimum time to remove the plurality of support materials from the object under a constraint that the build portions are sufficiently supported and protected during the fabrication of the object. The optimization model operates with reference to the identified support condition of the build portions, the data describing physical properties of a plurality of different support materials, the data describing a plurality of removal processes corresponding to the plurality of support materials, the data describing various arrangements of different support materials in conjunction with build portions, and optionally with reference to the identified build portion at risk during a particular removal process and the other support material having a removal process that does not pose a risk of damage or deformation to the identified build portion.

In one embodiment, the generation of the arrangement (block 908) includes generating a plurality of different arrangements under the constraint of satisfying the support condition of the build portions, evaluating a time needed to remove the support materials from the object, and selecting an arrangement from the plurality of different arrangements having the shortest removal time. In another embodiment, the generation is performed iteratively, where an initial arrangement is formed, and then the initial arrangement is iteratively modified at least in part and evaluated for time needed to remove the support materials. Such iteration could continue, for example, for a predetermined number of iterations, until the time for removal is less than a predetermined threshold amount of time, or until the time for the removal for succeeding iterations of the arrangement varies less than predetermined threshold of variance and reaches a steady state. The generation and modification can be random, can be based upon criteria such as the identified support condition of the build portions, the data describing physical properties of a plurality of different support materials, the data describing a plurality of removal processes corresponding to the plurality of support materials, the data describing various arrangements of different support materials in conjunction with build portions, and optionally with reference to the identified build portion at risk during a particular removal process and the other support material having a removal process that does not pose a risk of damage or deformation to the identified build portion. The generation and modification can also be based at least in part upon predetermined instructions, an algorithm, or other mathematical processes. In one embodiment, a plurality of different arrangements is generated, each arrangement is iterated, and an iterated arrangement with a lowest support material removal time is selected. In one embodiment, a genetic algorithm is used to generate the arrangement.

Three-dimensional data describing a geometry of a three-dimensional object that includes the generated arrangement of the plurality of support materials and the build portions are generated with reference to the three-dimensional data describing the geometry of the build portions and the generated arrangement of the plurality of support materials and the build portions (block 910). The three-dimensional data can then be output via the output device 808 to a three-dimensional object printer (block 912). The three-dimensional data can also be output to a user, or to other devices used with three-dimensional printing, such as devices configured to remove support materials from three-dimensionally printed objects.

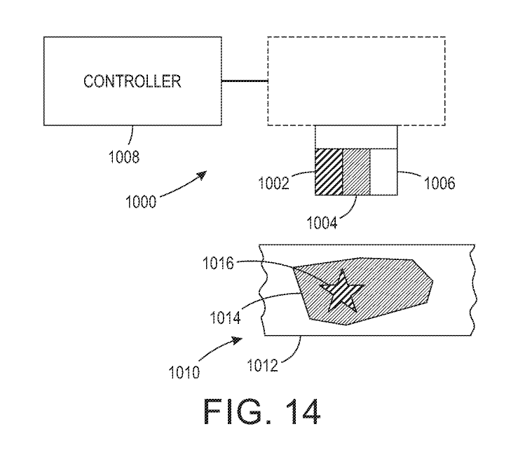

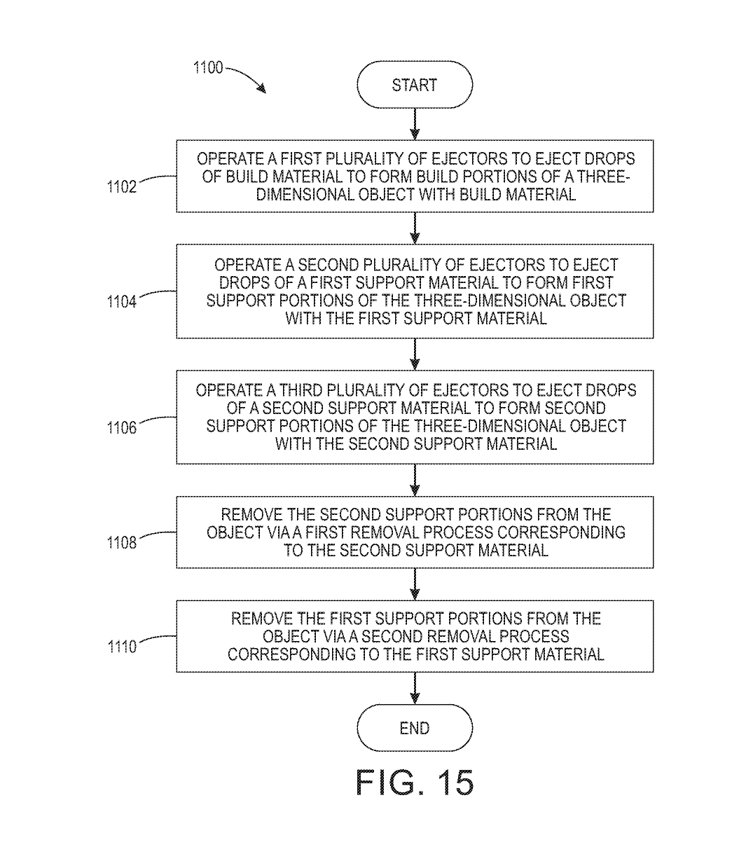

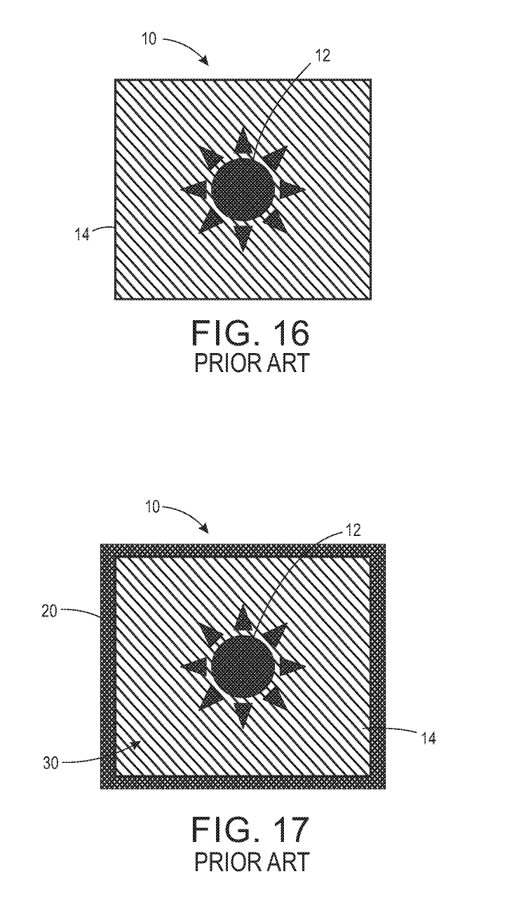

FIG. 14 illustrates an exemplary embodiment of a three-dimensional object printer 1000 configured to perform the exemplary method 1100 illustrated in FIG. 15 for producing a three-dimensionally printed object according to this disclosure. As illustrated in FIG. 14, the printer 1000 includes a first plurality of ejectors 1002, a second plurality of ejectors 1004, a third plurality of ejectors 1006, and a controller 1008. The first plurality of ejectors 1002 is configured to eject drops of a build material, the second plurality of ejectors 1004 is configured to eject drops of a first support material, and the third plurality of ejectors 1006 is configured to eject drops of a second support material that is different from the first support material. The controller 1008 is configured to operate the first, second, and third pluralities of ejectors 1002, 1004, and 1006 to form a three-dimensional object 1010 according to this disclosure that includes build portions 1012 formed with the build material, first support portions 1014 formed with the first support material, and second support portions 1016s formed with the second support material.

As illustrated in the method 1100 in FIG. 15, the controller 1008 is configured to perform the following process. The first plurality of ejectors 1002 is operated to eject drops of the build material to form build portions of a three-dimensionally printed object with the build material (block 1102). The second plurality of ejectors is operated to eject drops of the first support material to form first support portions of the three-dimensionally printed object with the first support material (block 1104). The third plurality of ejectors 1006 is operated to eject drops of the second support material to form second support portions of the three-dimensionally printed object with the second support material (block 1106).

In one embodiment, the controller 1008 (FIG. 14) is configured to receive three-dimensional data describing a geometry of a three-dimensional object according to this disclosure, such as the three-dimensional data generated by the system 800 using the method 900 (FIGS. 12 and 13). In another embodiment, the system 800 is integrated into the printer 1000. The controller 1008 is further configured to operate the first, second, and third pluralities of ejectors with reference to the three-dimensional data generated by the system 800 to print the object described by the three-dimensional data according to this disclosure.

After fabrication of the object with the printer, the object is removed from the printer and moved to one or more devices configured to remove the first and second support portions. In another embodiment, one or more devices configured to remove one or more support materials is integrated into the printer. The second support portions of the object are removed via first removal process corresponding to the second support material (block 1108). The first support portions of the object are removed via a second removal process corresponding to the first support material (block 1110). The second removal process is different from the first removal process, and the first support portions are not removed during the first removal process, such that the first support portions support and protect at least one of the build portions of the object. The first and second removal processes can be any acceptable type of removal process that corresponds to the second and first support materials, respectively, and can include, for example, a phase change operation, a dissolution operation, a wash operation, a pressure fluid application operation, a mechanical operation, or other types of acceptable removal operations. Devices configured to perform the first and second removal processes can be any type of acceptable device that would be known to one of ordinary skill in the art. In one embodiment, at least a portion of a removal process is performed manually or with the aid of a hand-held tool.

Those skilled in the art will recognize that numerous modifications can be made to the specific implementations described above. Therefore, the following claims are not to be limited to the specific embodiments illustrated and described above. The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A three-dimensionally printed object comprising:
portions formed with a build material;
portions formed with a first support material; and
portions formed with a second support material, the first support material being different from the second support material.

2. The three-dimensionally printed object of claim 1 wherein the first support material has a phase change temperature that is greater than a phase change temperature of the second support material.

3. The three-dimensionally printed object of claim 2 wherein the second support material can be removed by a heating process that heats the second support material to at least the phase change temperature of the second support material, but does not heat the first support material to at least the phase change temperature of the first support material.

4. The three-dimensionally printed object of claim 1 wherein the first support material dissolves in a solvent that is different than a solvent in which the second support material dissolves.

5. The three-dimensionally printed object of claim 4 wherein the first support material dissolves in a solvent having a ph factor that is less than the ph factor of the solvent in which the second material dissolves.

6. The three-dimensionally printed object of claim 1 wherein:
at least one of the portions formed with the first support material at least partially surrounds at least one of the portions formed with the build material; and
at least one of the portions formed from the second support material at least partially surrounds the at least one portion of the first support material that at least partially surrounds the at least one portion formed with build material.

7. The three-dimensionally printed object of claim 1 wherein the first support material is friable and the second support material is rigid.

8. The three-dimensionally printed object of claim 1 wherein:
the portions formed from the first support material can be removed from the three-dimensional object by a pressurized fluid, and
the portions formed from the second support material cannot be removed from the three-dimensional object by the pressurized fluid.

9. The three-dimensionally printed object of claim 1 wherein:
the portions formed with the build material include:
at least one portion having a minimum feature size greater than or equal to a threshold feature size; and
at least one portion having a minimum feature size less than the threshold feature size;
at least one portion of the first build material disposed on the at least one portion having a minimum feature size greater than or equal to the threshold feature size; and
at least one portion of the second build material disposed on the at least one portion having a minimum feature size less than the threshold feature size.

10. The three-dimensionally printed object of claim 1 wherein:
the portions formed with the build material define at least one internal cavity; and
at least one of the portions formed with the first support material is disposed within the at least one internal cavity.

11. The three-dimensionally printed object of claim 1, wherein at least one of the portions formed with the first support material is configured to form a support for at least one portion formed with the build material that is unconnected with the portions formed with the build material, in response to removal of the portions formed with the second support material from the three-dimensionally printed object.

12. A method of producing a three-dimensionally printed object comprising:
operating a first plurality of ejectors to eject drops of a build material to form portions of a three-dimensionally printed object with the build material;
operating a second plurality of ejectors to eject drops of a first support material to form portions of the three-dimensionally printed object with the first support material; and
operating a third plurality of ejectors to eject drops of a second support material to form portions of the three-dimensionally printed object with the second support material, wherein the second support material is different from the first support material.

13. The method of claim 12 further comprising:
identifying a support condition of the portions formed with the build material with reference to a geometry of the portions and physical properties of the build material; and
generating an arrangement of the portions formed with the first support material and the portions formed with the second support material to support the portions formed with the build material during the operation of first plurality of ejectors using an optimization model that optimizes for a minimum time to remove the portions formed with the first support material and the portions formed with the second material from the three-dimensionally printed object with reference to the identified support condition of the portions formed with the build material, physical properties of the first support material, and physical properties of the second support material; and
the operation of the second plurality of ejectors and the third plurality of ejectors performed with reference to the generated arrangement of the portions formed with the first support material and the portions formed with the second support material to support the portions formed with the build material during the operation of first plurality of ejectors.

14. The method of claim 13, the identifying the support condition of the portions formed with the build material further comprises at least one of:
identifying a portion formed with the build material as being at risk of damage during a process for removing the portions formed with the second support material from the three-dimensionally printed object; and
determining that the portion formed with the build material that is at risk of damage during the process for removing the portions formed with the second support material is not at risk of damage from a process for removing the portions formed with the first support material.

15. The method of claim 13 further comprising;
removing the portions formed with the second support material from the three-dimensionally printed object via a first removal process that does not remove the portions formed with the first support material; and
removing the portions formed with the first support material via a second removal process that is different than the first removal process.

16. The method of claim 15, the removal of the portions formed with the second support material further comprising:
heating the portions formed with the second support material to a temperature that is at least equal to a phase change temperature of the second support material and that is less than a phase change temperature of the first support material.

17. The method of claim 15, the removal of the portion formed with the second support material further comprising:
dissolving the portions formed with the second support material with a solvent that cannot dissolve the first support material.

18. The method of claim 15, the removal of the portions formed with the second support material further comprising:
directing pressurized fluid towards the portions formed from the second support material, the pressurized fluid having a pressure unable to remove the portions formed from the first support material.

19. The method of claim 13 further comprising:
forming at least one of the portions formed with the first support material to at least partially surround at least one of the portions formed with the build material; and
forming at least one of the portions formed with the second support material to at least partially surround the at least one portion of the first support material that at least partially surrounds the at least one portion formed with build material.
